(19) United States
(12) Patent Application Publication
(10) Pub. No.: US 2021/0311995 A1
(43) Pub. Date: Oct. 7, 2021

(54) INFORMATION PROCESSING APPARATUS

(71) Applicant: FUJIFILM BUSINESS INNOVATION CORP., Tokyo (JP)

(72) Inventor: Yoshifumi KANEKO, Kanagawa (JP)

(73) Assignee: FUJIFILM BUSINESS INNOVATION CORP., Tokyo (JP)

(21) Appl. No.: 17/126,311

(22) Filed: Dec. 18, 2020

(30) Foreign Application Priority Data
Apr. 6, 2020 (JP) 2020-068171

(51) Int. Cl. G06F 16/9035; G06F 16/908; G06F 16/9535

(52) U.S. Cl. CPC G06F 16/9035; G06F 16/9535; G06F 16/908

(57) ABSTRACT

An information processing apparatus includes a processor configured to acquire profile information for introducing a person, the profile information including at least one profile item, acquire current, actual information of the person, and in response to a variance between the acquired current information and the acquired profile information satisfying a condition, perform a process for reducing the variance.

### CROSS-REFERENCE TO RELATED APPLICATIONS

This application is based on and claims priority under 35 USC 119 from Japanese Patent Application No. 2020-068171 filed Apr. 6, 2020.

### BACKGROUND

### (i) Technical Field

The present disclosure relates to an information processing apparatus.

### (ii) Related Art

Japanese Unexamined Patent Application Publication No. 2002-118682 describes a technology in which profile information containing photos and texts related to persons who may make a phone conversation is displayed on a user's mobile phone, any person is selected as a phone conversation partner based on the displayed profile information, and a phone conversation is made by establishing connection between the user's mobile phone and a phone of the selected person using a phone number of the selected person.

### SUMMARY

Aspects of non-limiting embodiments of the present disclosure relate to the following circumstances. Some profile information of a person may become outdated as time goes on.

Aspects of non-limiting embodiments of the present disclosure therefore relate to reduction of a gap between the profile information and current information of the person.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to acquire profile information for introducing a person, the profile information including at least one profile item, acquire current, actual information of the person, and in response to a variance between the acquired current information and the acquired profile information satisfying a condition, perform a process for reducing the variance.

### BRIEF DESCRIPTION OF THE DRAWINGS

An exemplary embodiment of the present disclosure will be described in detail based on the following figures, wherein:

FIG. 1 illustrates the overall configuration of a matchmaking service providing system according to an exemplary embodiment;

FIG. 2 illustrates the hardware configuration of a server;

FIG. 3 illustrates the hardware configuration of a user terminal;

FIG. 4 illustrates a functional configuration implemented in the matchmaking service providing system;

FIG. 5 illustrates an example of an input screen;

FIG. 6 illustrates an example of stored profile information;

FIG. 7 illustrates an example of a search screen;

FIG. 8 illustrates an example of a search result screen;

FIG. 9 illustrates an example of a displayed notification;

FIG. 10 illustrates another example of the displayed notification;

FIG. 11 illustrates an example of an operation procedure in a registration process;

FIG. 12 illustrates an example of an operation procedure in an update process; and

FIG. 13 illustrates an example of a displayed notification according to a modified example.

### DETAILED DESCRIPTION

### [1] Exemplary Embodiment

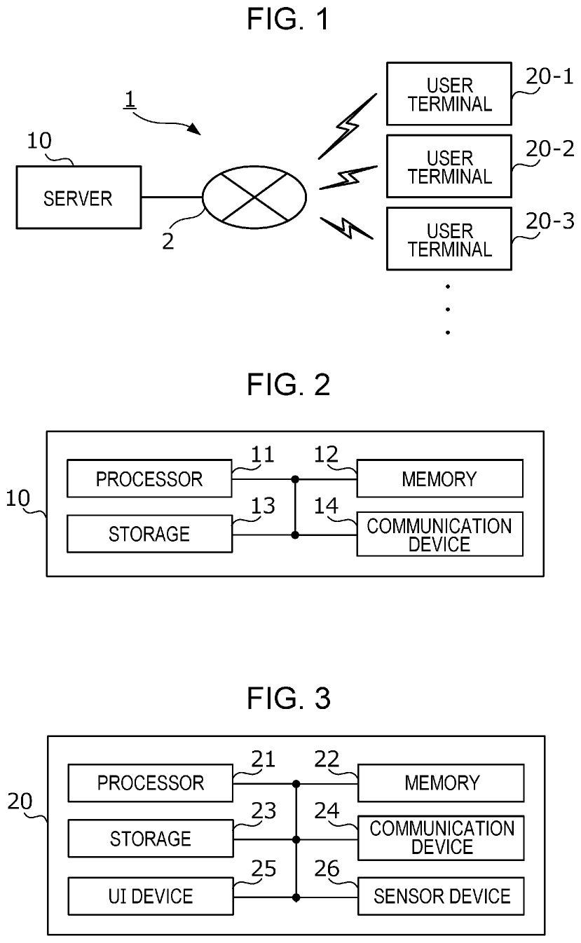

FIG. 1 illustrates the overall configuration of a matchmaking service providing system 1 according to an exemplary embodiment. The matchmaking service providing system 1 provides a matchmaking service for helping users making a match therebetween. In the matchmaking service, a person that a user wants to meet is retrieved based on the user's preferences, and the retrieved person is introduced to the user.

The matchmaking service providing system 1 includes a communication network 2, a server 10, and a plurality of user terminals 20-1, 20-2, 20-3, . . . (referred to as “user terminals 20” unless otherwise distinguished). The communication network 2 is a communication system including mobile communication networks and the Internet, and relays data exchange between apparatuses that access the system. The server 10 accesses the communication network 2 by wired communication. The user terminals 20 access the communication network 2 by wireless communication. Any apparatus may access the communication network 2 by wired or wireless.

The server 10 is an information processing apparatus that performs a process of storing users' preferences, and a process of searching for partners who meet the stored preferences (matchmaking process). Examples of the user terminal 20 include a smartphone, a tablet terminal, and a personal computer of a user registered as a member of the matchmaking service provided by the system.

FIG. 2 illustrates the hardware configuration of the server 10. The server 10 is a computer including a processor 11, a memory 12, a storage 13, and a communication device 14. The processor 11 includes an arithmetic device such as a central processing unit (CPU), a register, and a peripheral circuit. The memory 12 is a recording medium readable by the processor 11, and includes a random access memory (RAM) and a read only memory (ROM).

The storage 13 is a recording medium readable by the processor 11, and includes a hard disk drive or a flash memory. The processor 11 uses the RAM as a working area to execute programs stored in the ROM or the storage 13, thereby controlling operations of hardware. The communication device 14 has an antenna and a communication circuit, and performs communication via the communication network 2.

FIG. 3 illustrates the hardware configuration of the user terminal 20. The user terminal 20 is a computer including a processor 21, a memory 22, a storage 23, a communication device 24, a user interface (UI) device 25, and a sensor device 26. The processor 21 to the communication device 24 are the same types of hardware as the processor 11 to the communication device 14 of FIG. 2.

The UI device 25 is an interface provided for the user of the user terminal 20. For example, the UI device 25 has a touch screen including a display and a touch panel on the surface of the display to display images and receive user' operations. In addition to the touch screen, the UI device 25 has a keyboard or other operators to receive operations on the operators.

The sensor device 26 includes a positioning sensor, a speed sensor, an acceleration sensor, a temperature sensor, a humidity sensor, a photosensor, and various other sensors. In the matchmaking service providing system 1, the processors of the apparatuses described above control the individual parts by executing programs, thereby implementing the following functions. Operations of the functions are also described as operations performed by the processors of the apparatuses that implement the functions.

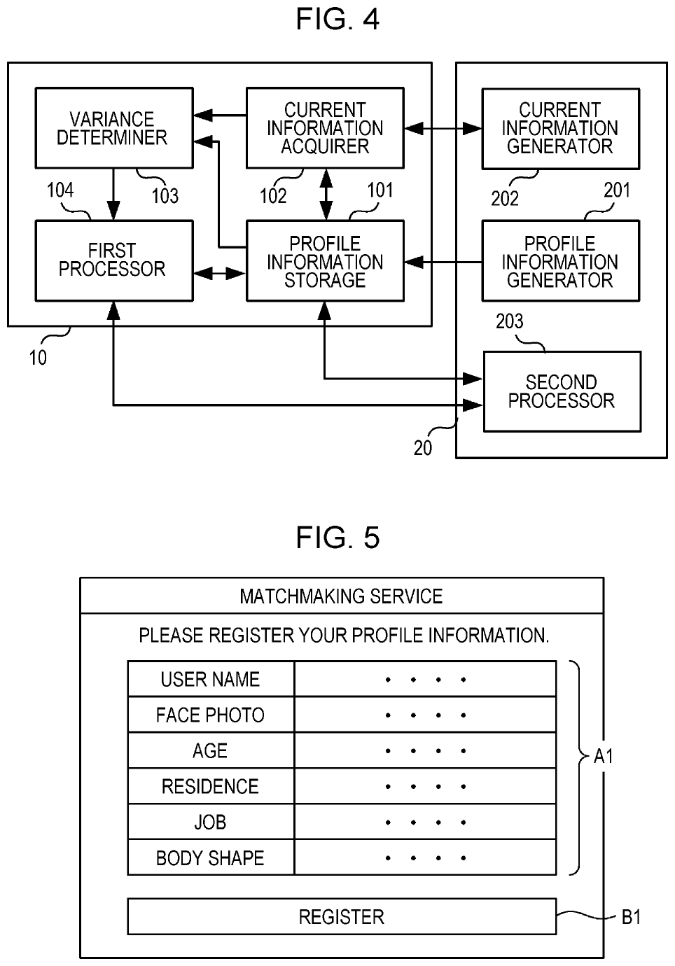

FIG. 4 illustrates a functional configuration implemented in the matchmaking service providing system 1. The server 10 includes a profile information storage 101, a current information acquirer 102, a variance determiner 103, and a first processor 104. The user terminal 20 includes a profile information generator 201, a current information generator 202, and a second processor 203.

The profile information generator 201 of the user terminal 20 generates profile information containing one or more profile items about a person. For example, the user terminal 20 displays an input screen for inputting the profile information.

FIG. 5 illustrates an example of the input screen. In the example of FIG. 5, the user terminal 20 causes a matchmaking service screen to display a message “Please register your profile information.” and input fields A1 for inputting user name, face photo, age, residence, job, and body shape. User name, face photo, age, residence, job, and body shape are examples of profile items.

The user terminal 20 displays a registration button B1. In response to the registration button B1 being pressed, the profile information generator 201 generates profile information comprising the information input from the input fields A1. The profile information generator 201 transmits the generated profile information to the server 10. The profile information storage 101 of the server 10 acquires the transmitted profile information including one or more profile items about a person.

The profile information storage 101 issues identification information of the person who is requesting registration of the profile information, and stores the acquired profile information in association with the issued identification information.

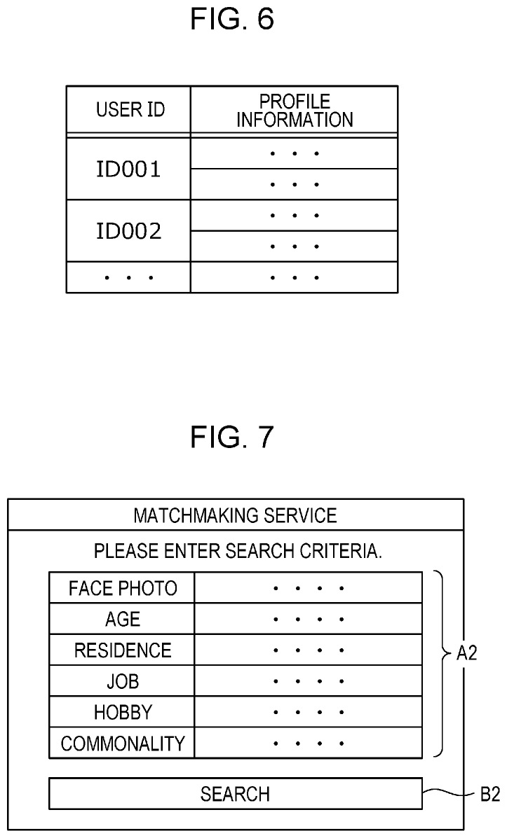

FIG. 6 illustrates an example of the stored profile information. In the example of FIG. 6, the profile information storage 101 stores pieces of profile information in association with user identifications (IDs) such as “ID001” and “ID002”.

The profile information storage 101 stores pieces of profile information of users of the matchmaking service. After the registration of the profile information, each user searches for a person that the user wants to meet. The user terminal 20 displays a search screen.

FIG. 7 illustrates an example of the search screen. In the example of FIG. 7, the user terminal 20 causes the matchmaking service screen to display a message “Please enter search criteria.” and input fields A2 for inputting face photo, age, residence, job, hobby, and commonality.

For example, a minimum number of registered face photos are input to the input field of face photo. An age group of the person that the user wants to meet is input to the input field of age. A residence, job, and hobby of the person are input to the input fields of residence, job, and hobby, respectively. A type of commonality is input to the input field of commonality. The commonality is a common profile item among users in the profile information. For example, an input of a commonality “job” triggers a search for a person having the same job as the user.

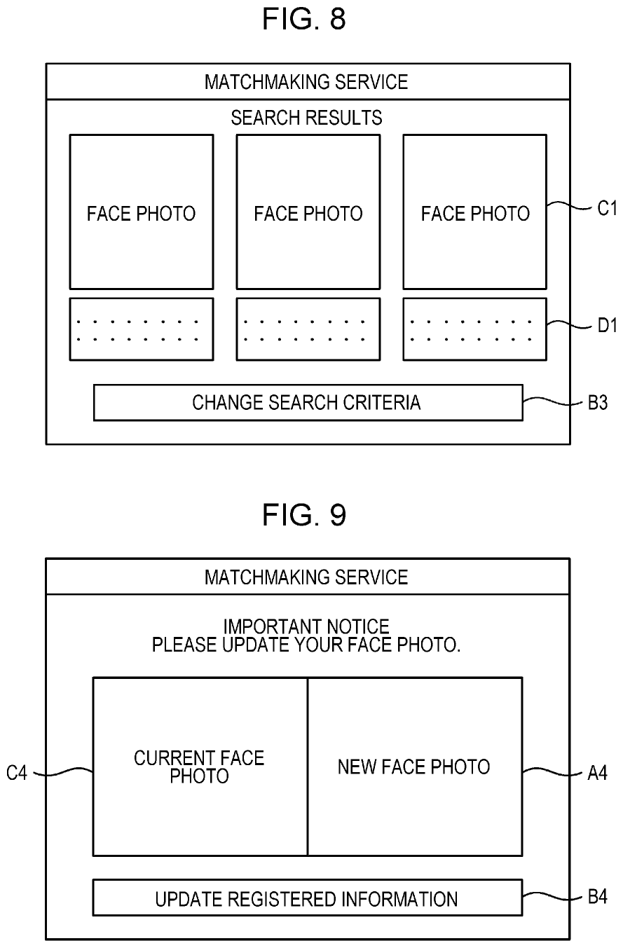

FIG. 8 illustrates an example of a search result screen. In the example of FIG. 8, the user terminal 20 causes the matchmaking service screen to display a title “Search Results”, face photos Cl and pieces of profile information D1 of retrieved persons, and a change button B3 for search criteria. In response to pressing the change button B3, the screen goes back to the search screen of FIG. 7 and the search criteria may be input again. The functions described above operate when the user uses the matchmaking service.

In the matchmaking service providing system 1, the profile information is, for example, periodically checked irrespective of the use of the system by the users. At a checking time, the current information acquirer 102 of the server 10 acquires current information of a person whose profile information is registered (hereinafter referred to as “registered user”). The current information indicates current profile items in the profile information.

Examples of the current information include a newer face photo of the registered user than the registered photo, and a current residence, a current job, and a current hobby of the registered user. To acquire the current information, the current information acquirer 102 transmits request data to the user terminal 20 to request the current information. The current information generator 202 of the user terminal 20 generates the current information of the registered user in response to the transmitted request data.

For example, in response to a request for current information indicating a newer face photo of the user than the registered photo, the current information generator 202 clips a face similar to the face in the registered face photo of the user out of photo data stored in the user terminal 20, and generates current information indicating the face obtained by clipping. For example, in response to a request for current information indicating a current residence of the registered user, the current information generator 202 reads records of positional information of the user terminal 20, and generates current information indicating a residence where the user stays for the longest time at night.

For example, in response to a request for current information indicating a current job of the registered user, the current information generator 202 reads the records of positional information of the user terminal 20, and generates current information indicating a job estimated based on a company where the user stays for the longest time during the daytime of weekdays. Examples of the estimated job include a healthcare worker at a hospital, a clerk at a department store, a public employee at a city hall, and a railroad company employee at a station.

For example, in response to a request for current information indicating a current hobby of the registered user, the current information generator 202 reads purchasing records of online shops in the user terminal 20, and generates current information indicating a hobby estimated based on goods purchased by the registered user. Examples of the estimated hobby include golf in a case of golf balls and golf clubs, soccer in a case of soccer jerseys, jogging in a case of jogging shoes, and video games in a case of video game software.

After the requested current information is generated, the current information generator 202 transmits the generated current information to the server 10. The current information acquirer 102 of the server 10 acquires the transmitted current information of the registered user. The current information acquirer 102 supplies the acquired current information to the variance determiner 103. The variance determiner 103 determines a variance between the profile information acquired by the profile information storage 101 and the current information acquired by the current information acquirer 102.

For example, if the profile information includes property information indicating a property of the registered user, the variance determiner 103 determines the variance described above by obtaining a difference between the property information in the profile information of the registered user and current property information of the registered user. Examples of the property information include information about the face photo, age, residence, job, or hobby of the registered user.

If the profile information includes property information indicating the face photo of the registered user, that is, image information indicating an image of the registered user, the variance determiner 103 obtains a difference in feature amounts between the image indicated by the image information and a current image of the registered user. The feature amount of the current image of the registered user is obtained based on the face photo of the registered user indicated by the acquired current information. The feature amount of the image may be obtained by using a known technology such as scale-invariant feature transform (SIFT) or speeded-up robust features (SURF).

If the property information indicates the age of the registered user, the variance determiner 103 obtains a determination result by calculating a difference between the age indicated by the property information and the age of the registered user indicated by the acquired current information. In this case, the variance described above increases as the calculated difference increases. If the property information indicates the residence of the registered user, the variance determiner 103 obtains a determination result by calculating a distance between the residence indicated by the property information and the residence of the registered user indicated by the acquired current information. In this case, the variance described above increases as the calculated distance increases.

If the property information indicates the job or hobby of the registered user, the variance determiner 103 presets, for example, similarities of all combinations of jobs or hobbies and obtains a determination result based on a similarity between the job or hobby indicated by the property information and the job or hobby indicated by the acquired current information. In this case, the variance described above increases as the similarity decreases. The variance determiner 103 supplies the determination result (e.g., the difference in feature amounts or ages) to the first processor 104.

If the variance determined by the variance determiner 103 satisfies a condition (condition for determining whether to execute a process), the first processor 104 performs a process for reducing the variance. In a case where the property information is used, the condition is satisfied, for example, when the difference between the property information in the profile information of the registered user and the current property information of the registered user is equal to or larger than a predetermined reference.

Examples of the process for reducing the variance include a process of prompting the registered user to register profile information close to the current information, and a process of notifying the registered user that the information of the registered user is old. Examples of the process for reducing the variance also include a process of recommending an action to the registered user so that the current information becomes close to the old registered information (e.g., a process of recommending that the registered user should dye his/her hair or take exercise to lose weight).

If the property information indicates the face photo of the registered user, the condition is satisfied when the calculated difference in feature amounts is equal to or larger than a reference. If the property information indicates the age or residence of the registered user, the condition is satisfied when the calculated difference in ages or the calculated distance between the residences is equal to or larger than a predetermined reference. If the property information indicates the job or hobby of the registered user, the condition is satisfied when the obtained similarity between the jobs or hobbies is smaller than a predetermined reference.

If the first processor 104 determines that the determination result supplied from the variance determiner 103 satisfies the condition, the first processor 104 in this exemplary embodiment performs, as the process for reducing the variance described above, a notification process for the registered user who has undergone the determination that the condition is satisfied. The first processor 104 transmits notification data to the user terminal 20 of the registered user. The second processor 203 of the user terminal 20 performs the process for reducing the variance similarly to the first processor 104.

The second processor 203 performs a notification process for notifying the user about the notification contained in the transmitted notification data as the process for reducing the variance by causing the display of the user terminal 20 to display the notification.

FIG. 9 illustrates an example of the displayed notification. In the example of FIG. 9, the second processor 203 causes the matchmaking service screen to display a title “Important Notice”, a message “Please update your face photo.”, a currently registered face photo C4, an input field A4 of new face photo, and an update button B4 for registered information.

The second processor 203 accesses the profile information storage 101 of the server 10 to read the face photo of the registered user, and displays the read face photo as the face photo C4. The first processor 104 may cause the notification data to contain the face photo of the registered user, and the second processor 203 may display the face photo. Alternatively, the first processor 104 may cause the notification data to contain the current face photo of the registered user that has been used in the variance determination, and the second processor 203 may display the face photo in the input field A4.

In response to pressing the update button B4, the second processor 203 transmits request data to the server 10 to request an update from the currently registered face photo C4 to the new face photo input in the input field A4. The first processor 104 of the server 10 requests the profile information storage 101 to update the face photo of the registered user to the face photo indicated by the received request data. The profile information storage 101 updates the face photo of the registered user as requested.

In this manner, the first processor 104 performs, as the process for reducing the variance described above, an update process for updating the profile information to current information of the registered user. If a plurality of determination results are obtained to show that the condition is satisfied, the first processor 104 performs a process for reducing the plurality of variances.

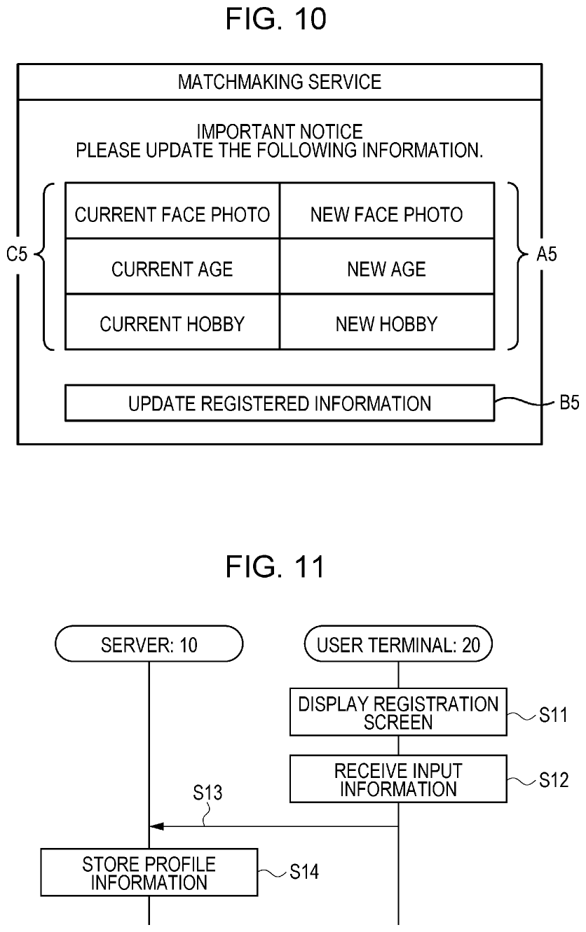

FIG. 10 illustrates another example of the displayed notification. In the example of FIG. 10, the second processor 203 causes the matchmaking service screen to display a title “Important Notice”, a message “Please update the following information.”, currently registered information C5 (face photo, age, and hobby), input fields A5 for inputting new information, and an update button B5 for registered information. In response to pressing the update button B5, the profile information is updated to the information input in the input fields A5.

With the configurations described above, the apparatuses of the matchmaking service providing system 1 perform the registration process for registering profile information, and the update process for updating the registered profile information to reduce the variance described above in the profile information.

FIG. 11 illustrates an example of an operation procedure in the registration process. First, the user terminal 20 displays a registration screen of FIG. 5 (Step S11) and receives information input to the registration screen (Step S12). The user terminal 20 (profile information generator 201) generates profile information based on the input information and transmits the profile information to the server 10 (Step S13). The server 10 (profile information storage 101) acquires and stores the transmitted profile information to register the profile information (Step S14).

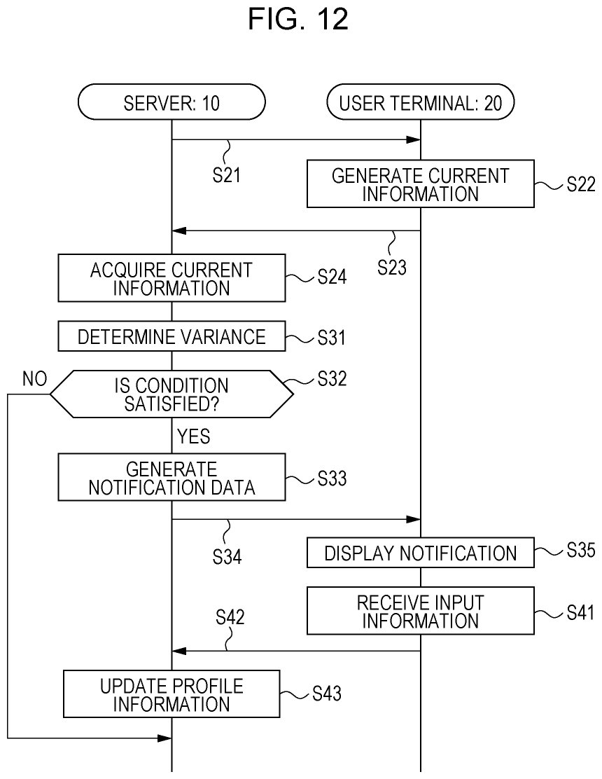

FIG. 12 illustrates an example of an operation procedure in the update process. First, the server 10 (current information acquirer 102) transmits request data to the user terminal 20 to request current information (Step S21). The user terminal 20 (current information generator 202) generates the current information of the registered user in response to the transmitted request data (Step S22) and transmits the generated current information to the server 10 (Step S23). The server 10 (current information acquirer 102) acquires the transmitted current information of the registered user (Step S24).

The server 10 (variance determiner 103) determines a variance between the acquired profile information and the acquired current information (Step S31). Then, the server 10 (first processor 104) determines whether a variance determination result satisfies the condition (Step S32). If the server 10 (first processor 104) determines that the condition is not satisfied (NO), this operation procedure is terminated.

If the server 10 (first processor 104) determines that the variance determination result satisfies the condition (YES), the server 10 (first processor 104) generates notification data for notifying the registered user about a request to update the profile item that has undergone the determination that the condition is satisfied (Step S33) and transmits the generated notification data to the user terminal 20 of the registered user (Step S34). The user terminal 20 (second processor 203) causes the display of the user terminal 20 to display the notification indicated by the transmitted notification data (Step S35).

The user terminal 20 (second processor 203) receives input new information on the profile item to be updated (Step S41) and transmits request data to the server 10 to request an update of the profile information to the input new information (Step S42). The server 10 (first processor 104 and profile information storage 101) updates the profile information of the registered user to the new information indicated by the received request data (Step S43).

For example, the face photo of a person varies depending on aging, haircut, and a change in weight. Selection of a partner based on information before change may lead to a complaint that the partner looks different from his/her profile information. This exemplary embodiment provides the process for reducing the variance between the acquired profile information and the acquired current information. In this exemplary embodiment, the difference in property information is used as well.

Specifically, the image information indicating an image of a person is used as the property information. In this exemplary embodiment, the notification process for a person is performed as the process for reducing the variance described above. In this exemplary embodiment, the update process for the profile information is performed as the process for reducing the variance.

### [2] Modified Examples

### [2-1] Property Information

In the exemplary embodiment, the property information is the image information indicating an image of a person but is not limited thereto. For example, the property information may be body information indicating a numeric value related to the body of the registered user. Examples of the body information include information indicating a weight, a body fat percentage, or a muscle mass. In this case, the current information generator 202 generates, as the current information, body information based on, for example, records of the weight stored in a health management application of the user terminal 20.

The variance determiner 103 determines the variance described above by obtaining a difference between the body information in the profile information of the registered user and current body information of the registered user (e.g., a difference in weights). The first processor 104 determines whether to perform the process for reducing the variance by using a condition to be satisfied when the difference in the body information obtained as the determination result is equal to or larger than a predetermined reference.

The property information may be tendency information indicating a tendency of activities of the registered user. Examples of the tendency information include records of results of positional measurement for the user terminal 20 by the positioning sensor. For example, the profile information generator 201 generates, as the profile information, tendency information based on the records of positional information of the user terminal 20, and the profile information storage 101 stores the generated profile information. The current information generator 202 generates, as the current information, tendency information based on the records of positional information of the user terminal 20.

The variance determiner 103 determines the variance described above by obtaining a difference between the tendency information in the profile information of the registered user and current tendency information of the registered user. For example, the variance determiner 103 determines the tendency of activities of the registered user based on a place where the registered user has stayed for the longest time in a day. If the registered user has stayed for the longest time at a company, the variance determiner 103 determines that the registered user has a tendency to work in that day. If the registered user has stayed for the longest time at a golf course, the variance determiner 103 determines that the registered user has a tendency to play golf in that day.

For example, the variance determiner 103 determines tendencies in individual days of each month, and uses tendency information obtained by summarizing the tendencies. For example, the variance determiner 103 uses, for a certain registered user, tendency information indicating a tendency of activities that the user works on weekdays, has a rest at home on Saturdays, and goes for golf on Sundays. For another registered user, the variance determiner 103 uses tendency information indicating a tendency of activities that the user works on weekdays, visits resorts on Saturdays, and goes out to a town on Sundays.

The variance determiner 103 compares, for the certain registered user, the tendency information stored in the profile information storage 101 and the tendency information acquired as the current information. The variance determiner 103 obtains, as the difference described above, the total days of week when the tendency of activities of the registered user has changed. The variance described above increases as the obtained difference (the number of days of week when the tendency of activities has changed) increases.

The first processor 104 determines whether to perform the process for reducing the variance by using a condition to be satisfied when the obtained difference is equal to or larger than a reference. Thus, the notification process or the update process described in the exemplary embodiment is performed for the registered user whose activity pattern has changed greatly.

The tendency information is not limited to the information described above. For example, the number of walk steps or a moving distance measured by the user terminal 20 may be used. Further, posts on a website or a social networking service (SNS) viewed by using the user terminal 20 may be used as the tendency information. In short, any information may be used as the tendency information as long as the information indicates the tendency of activities of the registered user.

### [2-2] Presenting of Options

In the exemplary embodiment, the notification process and the update process are performed as the process for reducing the variance described above but the process for reducing the variance is not limited thereto. The first processor 104 may perform, as the process for reducing the variance, a presenting process for presenting options of information for an update of the profile information to the registered user. For example, if the property information indicates the face photo of the registered user, the first processor 104 causes the notification data to contain two or more current face photos of the registered user that have been used in the variance determination.

The second processor 203 displays the two or more face photos indicated by the notification data in the input field A4 as the options.

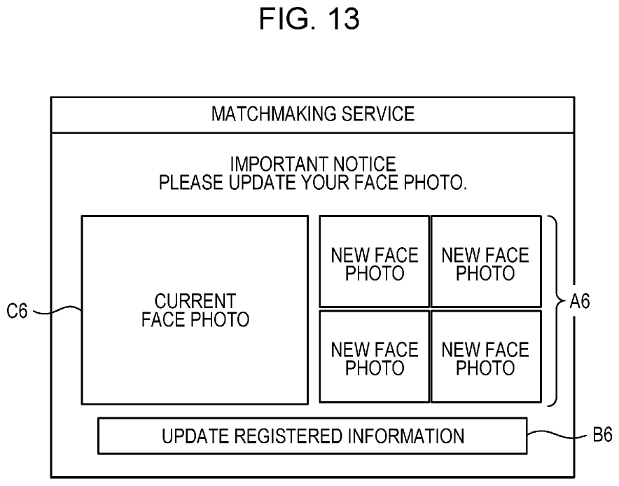

FIG. 13 illustrates an example of a displayed notification according to this modified example. In the example of FIG. 13, the second processor 203 causes the matchmaking service screen to display a title “Important Notice”, a message “Please update your face photo.”, a currently registered face photo C6, option images A6 showing four new face photos, and an update button B6 for registered information.

In response to the registered user selecting one face photo from the displayed option images A6 and pressing the update button B6, the profile information is updated to the selected face photo similarly to the exemplary embodiment. In this modified example, if two or more jobs or hobbies are estimated from the records of positional information, the two or more jobs or hobbies may be used as the options of update information.

### [2-3] Profile Items of Profile Information

The information to be used as the profile information is not limited to the information described above. For example, a full-body photo of the registered user, a skill, an activity amount of the registered user (information measured by a wearable terminal), a message created by the registered user, a link to an SNS of the registered user, or a photo taken by the registered user may be used as the profile information. In short, any information may be used as the profile information as long as the registered user wants to use the information to introduce himself/herself.

### [2-4] Dynamic Change in Processes

The same process may be performed every time among the notification process, the update process, and the presenting process serving as the process for reducing the variance described above. Alternatively, the process to be executed may dynamically be changed depending on situations. For example, at least one of the image information indicating an image of a person, the body information indicating a numeric value related to the body of the person, or the tendency information indicating a tendency of activities of the person is used as the property information in the profile information.

For example, a first user registers image information and body information, and a second user registers image information, body information, and tendency information. In this case, the first processor 104 and the second processor 203 vary the types of the process for reducing the variance depending on the types of the property information in the profile information. Specifically, if the profile information includes image information, the first processor 104 and the second processor 203 perform the notification process and the presenting process to prompt the registered user to select a new face photo without automatically updating the current face photo.

If the profile information includes body information, the first processor 104 performs the update process alone because the registered user is not able to change or select the record of the body information by his/her intention. In this case, the notification process may be performed to notify the registered user that the update process has been performed. If the profile information includes both image information and body information, two methods are available.

In the first method, the first processor 104 performs the notification process and the presenting process for the image information, and performs the update process alone for the body information. In the second method, the first processor 104 performs the notification process and the presenting process for both the image information and the body information. Both cases are common in that the types of the process for reducing the variance are determined depending on the types of the property information in the profile information.

### [2-5] Tendency of Change in Property Information

If the property information changes, the likelihood of satisfaction of the condition may be changed depending on whether the change is fast or slow. In this modified example, the first processor 104 determines a tendency of change in the property information, and changes the reference for use in the determination on the condition based on the determined change tendency. For example, if the property information is body information indicating the weight of the registered user, the weight may tend to increase or decrease.

For example, the first processor 104 determines a weekly tendency of increase or decrease in the weight by reading the records of the weight stored in the health management application of the user terminal 20. For example, the first processor 104 sets the reference to 4 kilograms (kg) if the determined increase or decrease tendency indicates that the weight increases or decreases only slightly within a range of less than 0.5 kg per week. The first processor 104 sets the reference to 3 kg if the increase or decrease tendency indicates that the weight increases or decreases by 0.5 kg or more per week.

For the registered user whose weight tends to increase or decrease, the condition is satisfied and the notification process and the update process are performed earlier than in the case where the reference is uniformly 4 kg.

### [2-6] Functional Configuration

In the matchmaking service providing system 1, the method for implementing the functions illustrated in FIG. 4 is not limited to the method described in the exemplary embodiment. For example, the server 10 may have all the elements in one housing or may have the elements distributed in two or more housings like computer resources provided in a cloud service.

For example, the variance determiner 103 performs the process of obtaining the difference in feature amounts and the process of determining the variance based on the obtained difference. Those processes may be performed by different functions. For example, the operations of the variance determiner 103 and the first processor 104 may be performed by one function. In short, the configurations of the apparatuses that implement the functions and the operation ranges of the functions may freely be determined as long as the functions illustrated in FIG. 4 are implemented in the matchmaking service providing system as a whole.

### [2-7] Processor

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### [2-8] Category

The exemplary embodiment of the present disclosure may be regarded not only as information processing apparatuses such as the server 10 and the user terminal 20 but also as an information processing system including the information processing apparatuses (e.g., matchmaking service providing system 1). The exemplary embodiment of the present disclosure may also be regarded as an information processing method for implementing processes to be performed by the information processing apparatuses, or as programs causing computers of the information processing apparatuses to implement functions. The programs may be provided by being stored in recording media such as optical discs, or may be installed in the computers by being downloaded via communication networks such as the Internet.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising a processor configured to
acquire profile information for introducing a person, the profile information including at least one profile item,
acquire current, actual information of the person, and
in response to a variance between the acquired current information and the acquired profile information satisfying a condition, perform a process for reducing the variance.

2. The information processing apparatus according to claim 1,
wherein the profile information includes property information indicating a property of the person, and
wherein the condition is satisfied when a difference between the property information in the profile information and current property information of the person is equal to or larger than a predetermined reference.

3. The information processing apparatus according to claim 2,
wherein the property information is image information indicating an image of the person, and
wherein the condition is satisfied when a difference in feature amounts between the image indicated by the image information in the profile information and a current image of the person is equal to or larger than the reference.

4. The information processing apparatus according to claim 2,
wherein the property information is body information indicating a numeric value related to a body of the person, and
wherein the condition is satisfied when a difference between the body information in the profile information and current body information of the person is equal to or larger than the reference.

5. The information processing apparatus according to claim 2,
wherein the property information is tendency information indicating a tendency of activities of the person, and
wherein the condition is satisfied when a difference between the tendency information in the profile information and current tendency information of the person is equal to or larger than the reference.

6. The information processing apparatus according to claim 2,
wherein the property information is at least one of image information indicating an image of the person, body information indicating a numeric value related to a body of the person, or tendency information indicating a tendency of activities of the person, and
wherein the processor is configured to vary types of the process depending on types of the property information in the profile information.

7. The information processing apparatus according to claim 3,
wherein the property information is at least one of the image information indicating the image of the person, body information indicating a numeric value related to a body of the person, or tendency information indicating a tendency of activities of the person, and
wherein the processor is configured to vary types of the process depending on types of the property information in the profile information.

8. The information processing apparatus according to claim 4,
wherein the property information is at least one of image information indicating an image of the person, the body information indicating the numeric value related to the body of the person, or tendency information indicating a tendency of activities of the person, and
wherein the processor is configured to vary types of the process depending on types of the property information in the profile information.

9. The information processing apparatus according to claim 5,
wherein the property information is at least one of image information indicating an image of the person, body information indicating a numeric value related to a body of the person, or the tendency information indicating the tendency of the activities of the person, and
wherein the processor is configured to vary types of the process depending on types of the property information in the profile information.

10. The information processing apparatus according to claim 2, wherein the processor is configured to
determine a tendency of change in the property information, and
change the reference based on the determined tendency of change.

11. The information processing apparatus according to claim 3, wherein the processor is configured to
determine a tendency of change in the property information, and
change the reference based on the determined tendency of change.

12. The information processing apparatus according to claim 4, wherein the processor is configured to
determine a tendency of change in the property information, and
change the reference based on the determined tendency of change.

13. The information processing apparatus according to claim 5, wherein the processor is configured to
determine a tendency of change in the property information, and
change the reference based on the determined tendency of change.

14. The information processing apparatus according to claim 6, wherein the processor is configured to
determine a tendency of change in the property information, and
change the reference based on the determined tendency of change.

15. The information processing apparatus according to claim 7, wherein the processor is configured to
determine a tendency of change in the property information, and
change the reference based on the determined tendency of change.

16. The information processing apparatus according to claim 8, wherein the processor is configured to
determine a tendency of change in the property information, and
change the reference based on the determined tendency of change.

17. The information processing apparatus according to claim 9, wherein the processor is configured to
determine a tendency of change in the property information, and
change the reference based on the determined tendency of change.

18. The information processing apparatus according to claim 1, wherein the process is a notification process for the person.

19. The information processing apparatus according to claim 1, wherein the process is a presenting process for presenting, to the person, options of information for an update of the profile information.

20. The information processing apparatus according to claim 1, wherein the process is an update process for updating the profile information to the current information of the person.
